(19) United States
(12) Patent Application Publication
(10) Pub. No.: US 2026/0359433 A1
(43) Pub. Date: Nov. 12, 2026

(54) DETERMINATION METHOD, DETERMINATION APPARATUS, AND NON-TRANSITORY COMPUTER-READABLE STORAGE MEDIUM STORING PROGRAM

(71) Applicant: Panasonic Intellectual Property Management Co., Ltd., Osaka (JP)

(72) Inventors: HIROYUKI OKADA, Osaka (JP); TATSUMI OBA, Chiba (JP); TAKAHIRO ADACHI, Hyogo (JP)

(21) Appl. No.: 19/727,043

(22) Filed: Jul. 1, 2026

Related U.S. Application Data
(63) Continuation of application No. PCT/JP2024/033059, filed on Sep. 17, 2024.
(60) Provisional application No. 63/621,307, filed on Jan. 16, 2024.

(30) Foreign Application Priority Data
May 30, 2024 (JP) 2024-087959

(51) Int. Cl. G06F 21/55

(52) U.S. Cl. CPC G06F 21/554; G06F 2221/033

(57) ABSTRACT

A determination method for determining whether target software is malicious, the determination method being executed by a computer, each piece of software including one or more functional units, includes extracting functional unit category information regarding the one or more functional units included in the target software, the functional unit category information being used to classify the one or more functional units into common categories in a first language for describing software and a second language for describing software, the second language being different from the first language, and determining, based on the extracted functional unit category information, whether the target software is malicious.

### BACKGROUND

### 1. Technical Field

The present disclosure relates to a determination method, a determination apparatus, and a non-transitory computer-readable storage medium storing a program.

### 2. Description of the Related Art

In recent years, use of open-source software (OSS) has become widespread, and attack methods targeting such OSS have also increased and diversified. In response to a wide variety of attack methods, there has been proposed a method for determining, by inference using machine learning trained on known attack methods, whether software includes an attack (or an anomaly) (see, for example, Sejfia et al., “Practical Automated Detection of Malicious npm Packages”, ICSE 2022).

### SUMMARY

On the other hand, there are cases where the above-described inference-based determination method is not readily applicable.

One non-limiting and exemplary embodiment provides a determination method and the like that enable expansion of applicability of an inference-based determination method.

In one general aspect, the techniques disclosed here feature a determination method for determining whether target software is malicious, the determination method being executed by a computer, each piece of software including one or more functional units, the determination method including extracting functional unit category information regarding the one or more functional units included in the target software, the functional unit category information being used to classify the one or more functional units into common categories in a first language for describing software and a second language for describing software, the second language being different from the first language, and determining, based on the extracted functional unit category information, whether the target software is malicious.

According to the present disclosure, applicability of an inference-based determination method can be expanded.

It should be noted that general or specific aspects may be implemented as a system, an apparatus, a method, an integrated circuit, a computer program, a non-transitory computer-readable storage medium such as a compact disc read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating functional configuration of a malicious software determination apparatus according to an embodiment;

FIG. 2 is a flowchart illustrating an example of operation of the malicious software determination apparatus according to the embodiment;

FIG. 3 is a flowchart illustrating a part of the operation of the malicious software determination apparatus according to the embodiment;

FIG. 4 is a diagram illustrating application programming interface (API) categorization according to the embodiment;

FIG. 5 is another diagram illustrating the API categorization according to the embodiment;

FIG. 6 is a flowchart illustrating another part of the operation of the malicious software determination apparatus according to the embodiment;

FIG. 7 is a diagram illustrating an example of extracted features according to the embodiment;

FIG. 8A is a diagram illustrating an example of distribution before domain adaptation according to the embodiment;

FIG. 8B is a diagram illustrating an example of distribution after domain adaptation according to the embodiment;

FIG. 9 is a flowchart illustrating another part of the operation of the malicious software determination apparatus according to the embodiment;

FIG. 10 is a flowchart illustrating another part of the operation of the malicious software determination apparatus according to the embodiment;

FIG. 11 is a diagram illustrating an example of a malicious software determination result according to the embodiment;

FIG. 12 is a flowchart illustrating another part of the operation of the malicious software determination apparatus according to the embodiment; and

FIG. 13 is a diagram illustrating information presented by the malicious software determination apparatus according to the embodiment.

### DETAILED DESCRIPTIONS

### Underlying Knowledge Forming Basis of Present Disclosure

In recent years, use of OSS has become widespread, and attack methods targeting such OSS have also increased and diversified. In response to a wide variety of attack methods, there has been proposed a method for determining, by inference using machine learning trained on known attack methods, whether software includes an attack (or an anomaly).

On the other hand, since various programming languages (hereinafter also simply referred to as “languages”) are used to describe software and a description style differs depending on the language, it is difficult to perform an inference-based determination for software described in a language different from a language used to describe software employed for the training (hereinafter also referred to as a “cross-language determination”). For example, there have been attempts to perform a cross-language determination using structural features of software. Such approaches use structural features such as the number of characters in a program and the number of files included in software, but since functional features such as APIs to be called are not used, code auto-generation or abuse of network communication functions may be overlooked, resulting in poor determination performance and lack of practical utility. As a result, such approaches suffer from poor determination performance and lack practical utility. Accordingly, an object of the present disclosure is to provide a determination method and the like that enable expansion of applicability of inference-based determination while maintaining determination performance, by performing cross-language determination using functional features of software.

More specifically, a determination method according to a first aspect of the present disclosure is a determination method for determining whether target software is malicious, the determination method being executed by a computer, each piece of software including one or more functional units, the determination method including extracting functional unit category information regarding the one or more functional units included in the target software, the functional unit category information being used to classify the one or more functional units into common categories in a first language for describing software and a second language for describing software, the second language being different from the first language, and determining, based on the extracted functional unit category information, whether the target software is malicious.

With the determination method, by extracting functional unit category information for classifying functional units included in software into common categories, the functional unit category information can be compared with one another for software of different languages. As a result, a model trained in such a way as to determine whether target software is malicious using functional unit category information can perform, based on extracted functional unit category information, an inference-based determination of whether the target software is malicious regardless of a language in which the target software is described. Therefore, such a method for determining whether target software is malicious by inference can be applied in a cross-language manner (applicability thereof can be expanded).

In addition, for example, a determination method according to a second aspect of the present disclosure is the determination method according to the first aspect, in which, in the determining, whether the target software is malicious is determined by inputting the extracted functional unit category information to a maliciousness determination model trained using at least one of the functional unit category information regarding the one or more functional units included in benign software or the functional unit category information regarding the one or more functional units included in malicious software. With this configuration, whether target software is malicious can be determined by inputting extracted functional unit category information to a maliciousness determination model.

In addition, for example, a determination method according to a third aspect of the present disclosure is the determination method according to the second aspect, further including constructing the maliciousness determination model using at least one of the functional unit category information regarding the one or more functional units included in the benign software or the functional unit category information regarding the one or more functional units included in the malicious software.

With this configuration, a maliciousness determination model can be constructed and used.

In addition, for example, the determination method according to a fourth aspect of the present disclosure is the determination method according to the third aspect, in which, in the constructing, adjustments for reducing a covariate shift between a distribution of the functional unit category information regarding the one or more functional units included in the target software and a distribution of the functional unit category information used to train the maliciousness determination model are made for the maliciousness determination model.

With this configuration, a maliciousness determination model with improved inference accuracy can be constructed as a result of the reduction in the covariate shift between the two distributions.

In addition, for example, a determination method according to a fifth aspect of the present disclosure is the determination method according to any of the second to fourth aspects, in which the target software is described in a language different from a language for describing at least one of the malicious software or the benign software including the one or more functional units relating to the functional unit category information used to train the maliciousness determination model.

With this configuration, whether target software described in a language different from a language for describing software used to train a maliciousness determination model is malicious can be determined.

In addition, for example, a determination method according to a sixth aspect of the present disclosure is the determination method according to any of the first to fifth aspects, in which, in the determining, a score indicating a likelihood that the target software is malicious is calculated based on the extracted functional unit category information, and whether the target software is malicious is determined based on the calculated score.

With this configuration, a score can be calculated for target software, and whether the target software is malicious can be determined based on the score.

In addition, for example, a determination method according to a seventh aspect of the present disclosure is the determination method according to any of the first to sixth aspects, in which the one or more functional units are application programming interfaces.

With this configuration, functional unit category information regarding APIs included in target software can be extracted and used.

In addition, for example, a determination method according to an eighth aspect of the present disclosure is the determination method according to any of the first to seventh aspects, further including calculating a degree of similarity between the functional unit category information regarding the one or more functional units included in the target software determined to be malicious and the functional unit category information regarding the one or more functional units included in reference software known to be malicious, and identifying, based on a result of the calculating, the reference software including the one or more functional units relating to the functional unit category information similar to the functional unit category information regarding the one or more functional units included in the target software determined to be malicious.

With this configuration, with respect to target software determined to be malicious, reference software known to be malicious and is similar to the target software can be identified based on a degree of similarity of functional unit category information.

In addition, for example, a determination method according to a ninth aspect of the present disclosure is the determination method according to any of the first to eighth aspects, further including estimating, in the target software determined to be malicious, a degree of contribution of each of the one or more functional units to the determination that the target software is malicious, and determining, based on a result of the estimating, a location in the target software where a malicious functional unit, among the one or more functional units, that contributes to the determination that the target software is malicious is described.

With this configuration, for each functional unit of the target software determined to be malicious, a location in the target software where a malicious functional unit that contributes to the determination that the target software is malicious is described can be determined.

In addition, for example, a determination method according to a tenth aspect of the present disclosure is the determination method according to any of the first to ninth aspects, further including estimating, in the target software determined to be malicious, a degree of contribution of each of the one or more functional units to the determination that the target software is malicious, and generating, based on a result of the estimating, information regarding an anomaly in the target software expected from, among the one or more functional units, a malicious functional unit that contributes to the determination that the target software is malicious.

With this configuration, with respect to functional units of target software determined to be malicious, information regarding an anomaly in the target software expected from a malicious functional unit that contributes to the determination that the target software is malicious can be generated.

In addition, for example, a determination method according to an eleventh aspect of the present disclosure is the determination method according to any of the first to tenth aspects, further including estimating, in the target software determined to be malicious, a degree of contribution of each of the one or more functional units to the determination that the target software is malicious, and removing, among the one or more functional units, a malicious functional unit that contributes to the determination that the target software is malicious from the target software based on a result of the estimating.

With this configuration, with respect to functional units of target software determined to be malicious, a malicious functional unit that contributes to the determination that the target software is malicious can be removed from the target software.

In addition, for example, a storage medium according to a twelfth aspect of the present disclosure is a non-transitory computer-readable storage medium storing a program causing the computer to execute the determination method according to any of the first to eleventh aspects.

With this configuration, the same effects as those produced by the determination method described above can be produced by executing the program stored in the storage medium using the computer.

In addition, for example, a determination apparatus according to a thirteenth aspect of the present disclosure is a determination apparatus that determines whether target software is malicious, each piece of software including one or more functional units, the determination apparatus including an extractor that extracts functional unit category information regarding the one or more functional units included in the target software, the functional unit category information being used to classify the one or more functional units into common categories in a first language for describing software and a second language for describing software, the second language being different from the first language, and a determiner that determines, based on the extracted functional unit category information, whether the target software is malicious.

With this configuration, the same effects as those produced by the determination method described above can be produced.

Furthermore, these general or specific aspects may be implemented as a system, an apparatus, a method, an integrated circuit, a computer program, a non-transitory storage medium such as a CD-ROM, or any selective combination thereof.

An embodiment will be specifically described hereinafter with reference to the drawings. Note that the embodiment described below is merely a general or specific example. Numerical values, shapes, materials, constituent elements, arrangement positions and connection modes of the constituent elements, steps, order of steps, and the like mentioned in the following embodiment are examples and are not intended to limit the present disclosure. Among the constituent elements in the following embodiment, those not recited in the independent claims are described as optional constituent elements. The drawings are schematic diagrams and are not necessarily drawn to scale. In the drawings, substantially identical configurations are denoted by the same reference signs, and redundant description may be omitted or simplified.

### Embodiment

### Configuration

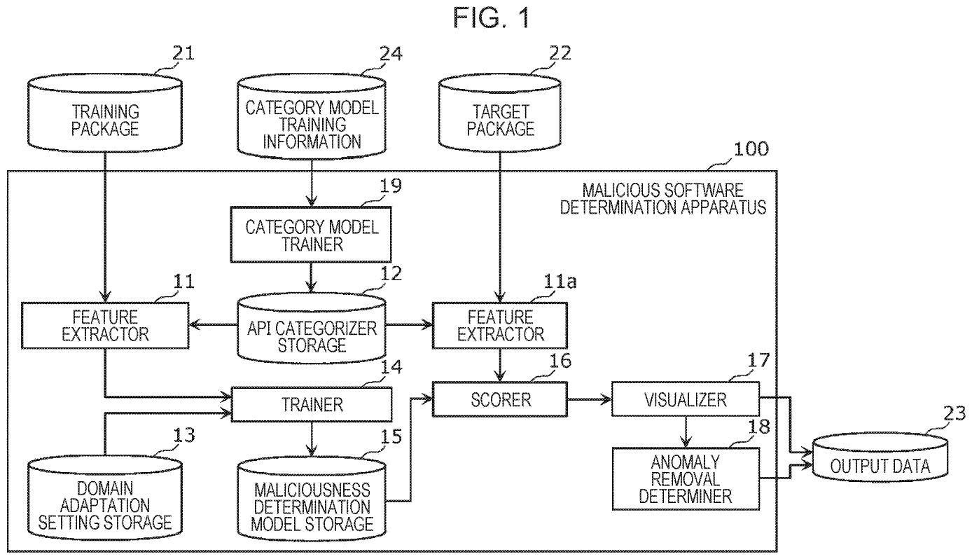

First, configuration of a malicious software determination apparatus according to an embodiment will be described. FIG. 1 is a block diagram illustrating functional configuration of the malicious software determination apparatus according to the embodiment. Note that FIG. 1 illustrates various types of information input to and output from a malicious software determination apparatus 100 along with the malicious software determination apparatus 100. The malicious software determination apparatus 100 according to the present embodiment is an example of a determination apparatus, and includes, as illustrated in FIG. 1, feature extractors 11 and 11a, an API categorizer storage 12, a domain adaptation setting storage 13, a trainer 14, a maliciousness determination model storage 15, a scorer 16, a visualizer 17, an anomaly removal determiner 18, and a category model trainer 19. The malicious software determination apparatus 100 is achieved by sequentially executing a predetermined program on a computer such as an information processing server using a processor and a memory.

In the malicious software determination apparatus 100 according to the present embodiment, a maliciousness determination model is constructed through machine learning, and whether target software to be inspected is malicious software is determined by inference using the maliciousness determination model. Note that the determination whether target software is malicious is at least one of a determination that target software is malicious, a determination that target software is not malicious but benign, a determination that target software is not malicious, or a determination that target software is not benign.

A maliciousness determination model is constructed by performing training using a benign software package (hereinafter a package is synonymous with software) described in language X and a malicious software package described in language X including, for example, malware. A training package 21 includes at least one of a benign package or a malicious package described in a first language. A training package may include a package described in a second language (e.g., language Y) different from the first language. This is preferable because a benign package described in language Y is readily available. In the present embodiment, a package described in two or more languages can be used to train a maliciousness determination model. This is because the feature extractor 11 is provided downstream of where the training package 21 is input, and feature category information, which is information regarding features based on language-independent common category classification, can be obtained.

A package, that is, software, includes one or more functional units. By performing category classification based on functional units, each of one or more functional units included in software can be classified into common categories in any language. That is, by extracting, from the software, functional unit category information indicating which categories of functional units the software is constructed from, functional features can be compared between pieces of software even when languages of the pieces of software differ. Accordingly, by performing training using the functional unit category information, a trained maliciousness determination model can be used in a cross-language manner even when a language of software used for the training differs from a language of software to be inspected.

A functional unit may be, for example, an API, for example, but may be defined in any other way insofar as the functional unit is a part of a program corresponding to one function, such as a function or a functional unit code.

The feature category information described above may include any information insofar as the feature category information includes at least the functional unit category information. In the present embodiment, the feature extractor 11 extracts, from the training package 21, feature category information including the functional unit category information and structural features.

In order to extract the functional unit category information, an API categorizer stored in the API categorizer storage 12 is used in the present embodiment. The API categorizer is constructed in advance by the category model trainer 19 and stored.

The category model trainer 19 can construct an API categorizer that associates API descriptions in the language with categories by using a large language model whose inputs are APIs defined for the target language, descriptions of the APIs based on official pages, definition documents, or the like, and category information defined in advance (all of these are included in category model training information 24). The categories here are common across the languages, and even if the language is different, APIs classified into the same category correspond to the same functional unit.

When the large language model is used, it is conceivable to use API names, descriptions, category information, and the like as data for fine tuning. When a target API is categorized, an API name and a description are used as inputs. The inputs, that is, the API name and the description, are converted into a vector by a natural language model, and the API is categorized by calculating which of pre-defined categories the vector is closest to.

The domain adaptation setting storage 13 stores information for domain adaptation processing used to train the maliciousness determination model. Due to a difference in language or the like, software used for training and target software might be different from each other in terms of how functional units are included. That is, there may be a covariate shift between a feature vector of features of the software used for training and a feature vector of features of the target software. In other words, the feature vector of the features of the software used for training and the feature vector of the features of the target software might have different domains. In consideration of such a difference in domain, determination accuracy can be improved by making adjustments for reducing the covariate shift.

The difference in domain here may be, for example, a difference in distribution between languages arising from a difference in trends of purposes for which a package is used, due to a training language and an inspection target language being different, such as Python (registered trademark) and JavaScript (registered trademark). Furthermore, the difference in domain refers to a difference in distribution between training and inspection that arises when a group of packages used for training is biased toward those used in a specific field of software development, whereas a package to be inspected is one that is frequently used in a field different from that of the group of packages used for training. In such a case, by adjusting the model using a so-called transfer learning model, the difference can be absorbed (i.e., the covariate shift can be reduced), thereby improving the determination accuracy.

The trainer 14 is a processor that trains and constructs a maliciousness determination model. The trainer 14 is an example of a constructor that constructs a maliciousness determination model through training. The trainer 14 stores the constructed maliciousness determination model in the maliciousness determination model storage 15.

In the construction of the maliciousness determination model, a machine learning model for determining whether a feature vector of input features is malicious is trained based on feature vectors of benign features and feature vectors of malicious features. A classifier such as a random forest can be used for the model. Since functional unit category information regarding categories of functional units common across languages can be used as features, the constructed maliciousness determination model can be used to inspect a feature vector whose features are functional unit category information extracted from a target package 22. The feature extractor 11a has the same functions as the feature extractor 11 except for a difference according to whether an input package is the training package 21 or the target package 22, and thus description thereof is omitted here.

The scorer 16 calculates, for the target package 22 to be inspected, a score indicating proximity to a feature vector of malicious features or distance from a feature vector of benign features as a likelihood of being malicious. If the score is higher than a predetermined threshold, the target package 22 is determined to be a malicious package (malicious software), and if the score is lower than or equal to the predetermined threshold, the target package 22 is determined to be a benign package (benign software). The scorer 16 thus functions as a determiner that determines whether target software is malicious based on a calculated score. Note that, as the determiner, a determiner that determines only whether target software is malicious may be provided.

The visualizer 17 visualizes a determination result in a form (e.g., as an image including information) that is easily understandable by a user. The visualizer 17 outputs an image or the like obtained as a result of the visualization as output data 23.

The anomaly removal determiner 18 is a functional portion that removes, from the target package 22 determined to be malicious, attack portions (anomalous portions) that constitute a cause of maliciousness. The anomaly removal determiner 18 outputs the package corrected through the removal as the output data 23.

### Operation

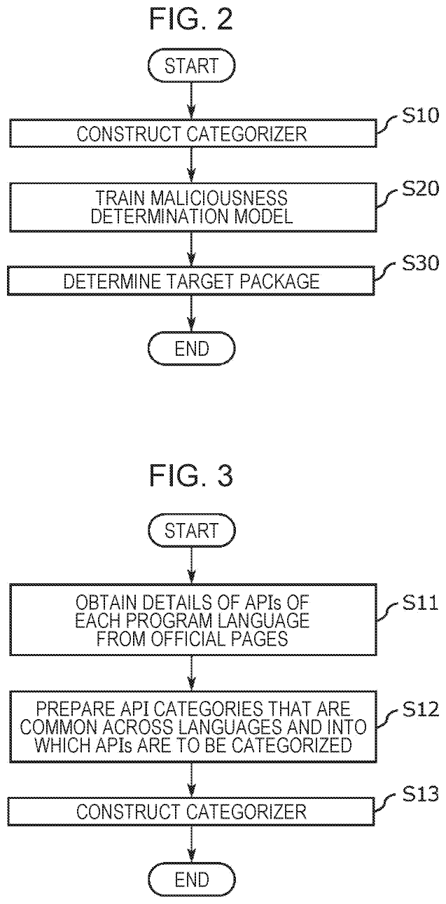

Next, an example of the operation of the malicious software determination apparatus 100 configured as described above will be described with reference to FIG. 2 and subsequent drawings.

FIG. 2 is a flowchart illustrating an example of the operation of the malicious software determination apparatus according to the embodiment. FIG. 3 is a flowchart illustrating a part of the operation of the malicious software determination apparatus according to the embodiment.

As illustrated in FIG. 2, first, the malicious software determination apparatus 100 constructs an API categorizer (S10). Here, FIG. 3 illustrates detailed operations in step S10 of FIG. 2. As illustrated in FIG. 3, the category model trainer 19 obtains details (i.e., the category model training information 24) of APIs from official pages of an organization that standardizes a programming language (S11). Language-independent API categories to which the APIs are to be categorized are then prepared manually or through machine learning (S12). The API categories are also obtained (read) by the category model trainer 19 as the category model training information 24. The category model trainer 19 then constructs an API categorizer and stores the API categorizer in the API categorizer storage 12 (S13).

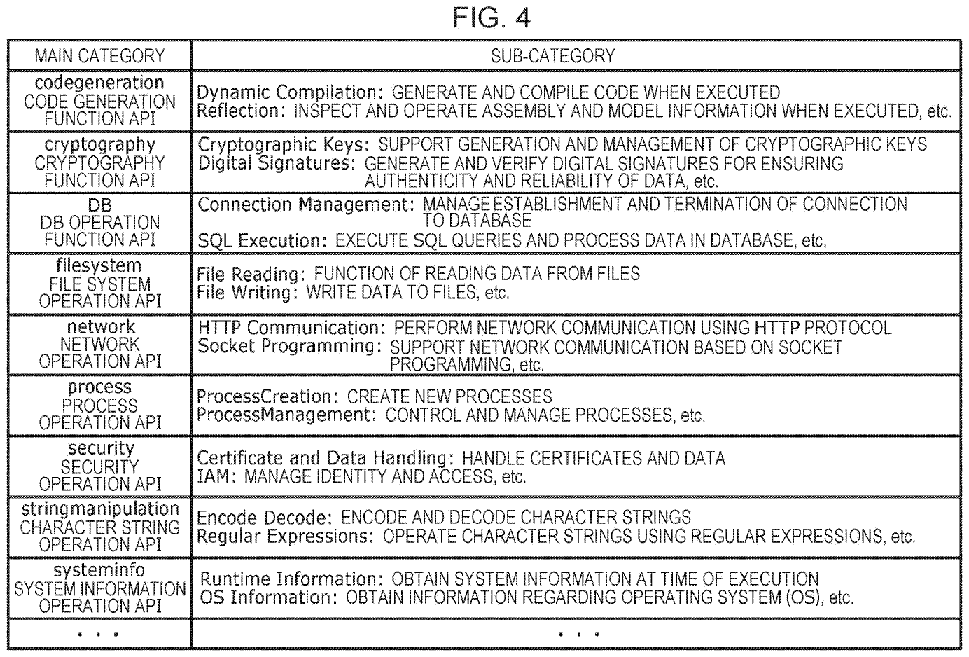

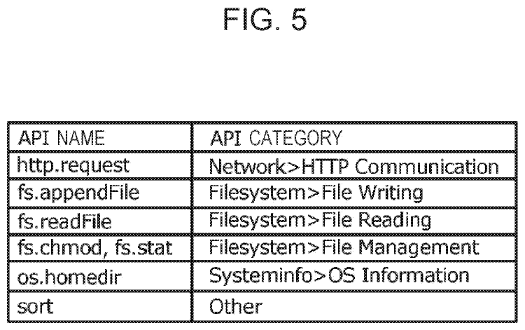

FIGS. 4 and 5 are diagrams illustrating API category classification according to the embodiment. In a method for categorizing an API, first, APIs of a language to be extracted are prepared as a list using a group of APIs called standard APIs, and whether the APIs appearing in the list are used in a package is extracted. The extracted APIs are then classified into predetermined categories of API functions frequently used by malware. That is, the API categories to be prepared need not be comprehensive, and may be narrowed down to ones that tend to be used for an attack. In case no category is applicable, a category “Others” or the like may be provided so that APIs will not be used as features. In addition, the API categories may have a hierarchical structure where main categories branch into sub-categories such as an “OS Information” category under a “Systeminfo” category.

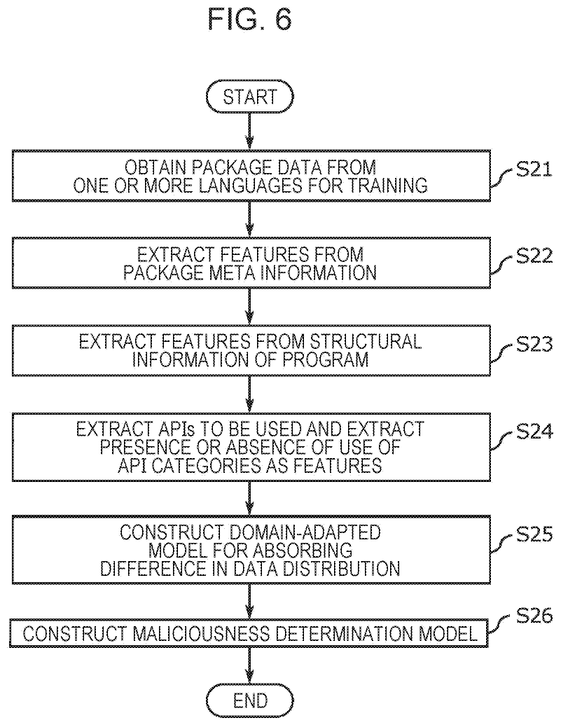

Referring back to FIG. 2, the trainer 14 constructs a maliciousness determination model by training (S20). FIG. 6 is a flowchart illustrating another part of the operation of the malicious software determination apparatus according to the embodiment. FIG. 6 illustrates detailed operations in step S20 of FIG. 2.

As illustrated in FIG. 6, the feature extractor 11 obtains one or more training packages 21 (S21). When package meta data such as update frequency, the number of pull requests, package names, and the like are available, the feature extractor 11 extracts these as part of the features (S22). These features are not structural features or functional features but other features. Because even such features may indicate maliciousness, the features may also be used in this manner.

The feature extractor 11 extracts, as part of the features, structural information of a program, such as the number of lines, the number of characters, and presence or absence of encoded character strings (S23). The features correspond to the structural features described above.

The feature extractor 11 also extracts APIs to be used in the training package 21 through a program analysis or the like, classifies the APIs into categories using the API categorizer, and extracts features (S24). The features correspond to the functional features described above.

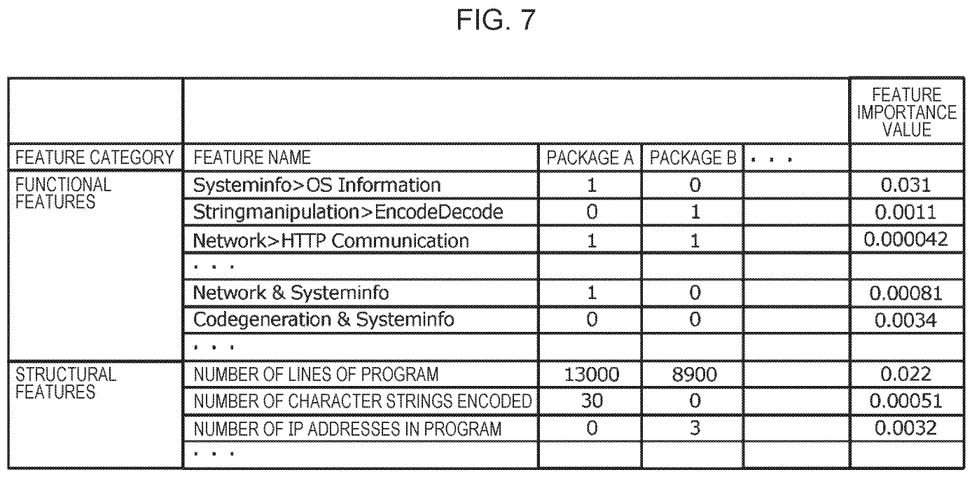

The features extracted in the above-described manner are grouped for each package as illustrated in FIG. 7. FIG. 7 is a diagram illustrating an example of the extracted features according to the embodiment. As illustrated in FIG. 7, the features used for training may be ones obtained by merging language-independent functional features extracted by, for example, categorizing APIs used in a package with structural features of a program or the like included in the package.

Here, examples of the structural features include, as described above, the number of lines of the program, the number of characters encoded, and hard-coded IP addresses. In addition to a feature indicating presence or absence of use of APIs associated with (or classified into) each category, the functional features may also include a feature indicating whether functions of a plurality of categories are used simultaneously. For example, “Network & Systeminfo” shown in the drawing is such a feature.

When a maliciousness determination model is trained and constructed using a random forest or the like based on features, it is possible to quantify how important each feature is for the determination. Similarly, such quantification can be performed by an explainable method such as SHapley Additive exPlanations (SHAP). Such numerical values will be referred to as “feature importance values” hereinafter. Based on information regarding the feature importance values, APIs used within a package determined to be malicious and associated with API categories having relatively large feature importance values (e.g., greater than or equal to a threshold or within top several percent) may be presented to the user. This enables the user to use the presented APIs as references in determining anomalousness of portions determined to be anomalous (i.e., whether the user regards the portions as anomalous).

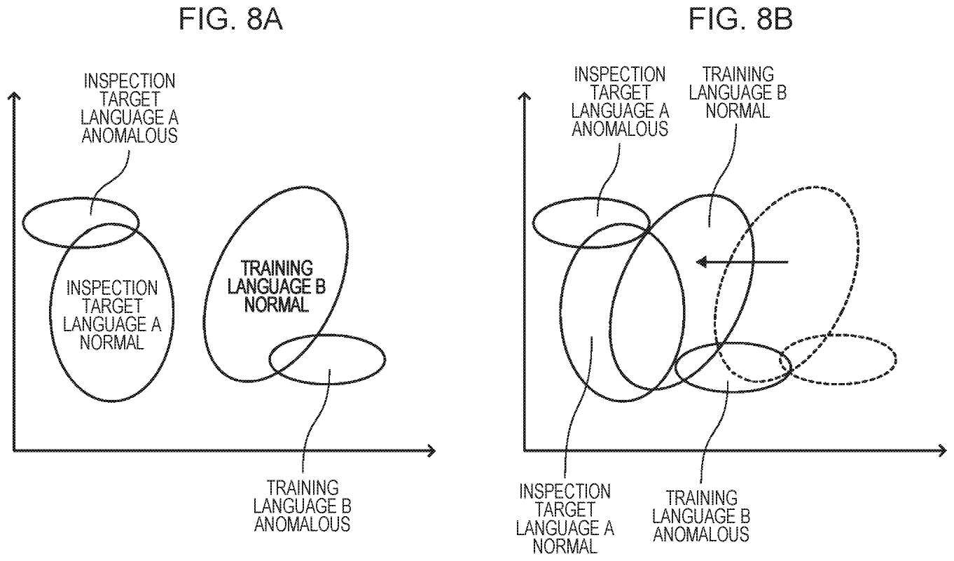

Referring back to FIG. 6, the trainer 14 constructs a model subjected to domain adaptation in such a way as to absorb a difference in distribution between the extracted features of the target package 22 and the extracted features of the training package 21 (i.e., to reduce a covariate shift) (S25). FIGS. 8A and 8B are diagrams illustrating an example of the domain adaptation according to the embodiment. FIGS. 8A and 8B are schematic diagrams of performing the domain adaptation: FIG. 8A illustrates a distribution before the adaptation and FIG. 8B illustrates a distribution after the adaptation.

For example, when different languages such as JavaScript (registered trademark) and Python (registered trademark) are used respectively as a language for describing the training package 21 and a language for describing the target package 22, there may be a bias in purposes of packages to be created, resulting in a possibility that data distributions differ. In this case, there is a possibility that the maliciousness determination model constructed from the training package 21 is not appropriately applicable to determining whether the target package 22 is malicious based on features thereof.

Accordingly, a domain adaptation technique may be employed. Even when a distribution of features extracted from the training package 21 differs from a distribution of features extracted from the target package 22 (i.e., domains differ), the maliciousness determination model can be configured to function properly by, for example, performing importance-weighted learning or feature transfer learning.

In addition to a case where different languages are used, a similar domain adaptation process can also effectively operate when, as described above, the training package 21 is a package frequently used in a specific field, such as embedded systems, whereas the target package 22 is a package frequently used in another field, such as Internet of Things (IoT) systems, and the difference in the field leads to a difference in domain and a decrease in accuracy.

Referring back to FIG. 6, the trainer 14 trains and constructs a maliciousness determination model using the information obtained in the above-described manner (S26).

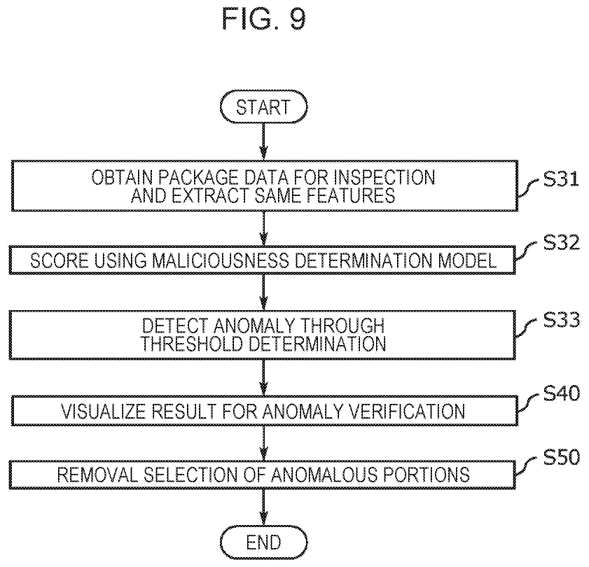

Referring back to FIG. 2, the scorer 16 determines whether the target package 22 is malicious using the constructed maliciousness determination model (S30). FIG. 9 is a flowchart illustrating another part of the operation of the malicious software determination apparatus according to the embodiment. FIG. 9 illustrates detailed operations in step S30 of FIG. 2.

As illustrated in FIG. 9, the feature extractor 11 obtains the target package 22 and extracts the same features as in steps S22 to S24 (extracts feature category information; S31). Next, the scorer 16 scores the extracted features using the constructed maliciousness determination model (S32). The scorer 16 detects anomalies in the target package 22 based on a threshold determination based on the calculated scores (S33). If anomalies are detected, the target package is determined to be malicious.

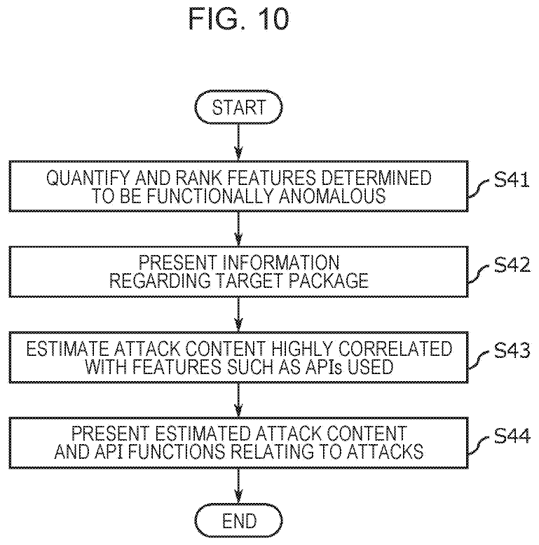

The visualizer 17 visualizes the determination result in order for the user to verify anomalousness of locations in which anomalies have been detected (S40). Here, FIG. 10 is a flowchart illustrating another part of the operation of the malicious software determination apparatus according to the embodiment. FIG. 10 illustrates detailed operations in step S40 of FIG. 9.

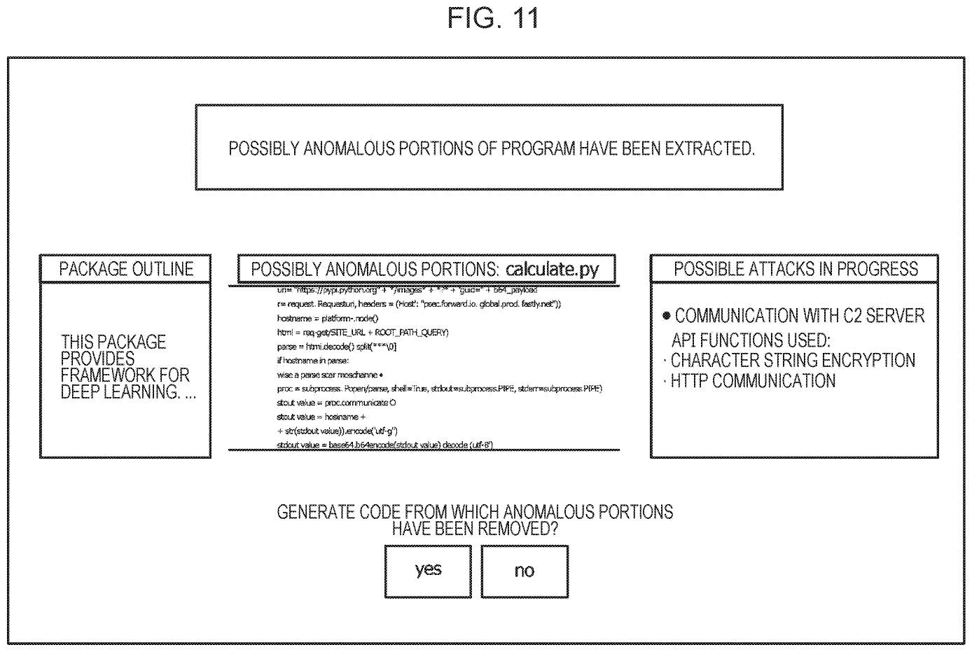

The visualizer 17 quantifies the features determined to be functionally anomalous and ranks the features in order of a likelihood of anomaly (S41). The visualizer 17 presents information regarding the target package 22 by including the information in the visualized information (S42). The visualizer 17 also estimates attack content highly correlated with the features such as APIs used (S43). The visualizer 17 then presents the estimated attack content and the API functions relating to attacks by including the attack content and the API functions in the visualized information (S44). FIG. 11 is a diagram illustrating an example of a malicious software determination result according to the embodiment. As illustrated in FIG. 11, locations in the program within the package that may be anomalous, attacks that may be being conducted, and an outline of the package are presented, and the user can verify, based on this information, anomalousness of the portions of the target package 22 in which anomalies have been detected. It should be noted that FIG. 11 is a schematic image illustrating an example of a screen display of visualized information. Accordingly, even if characters, symbols, or details of program locations shown in FIG. 11 are difficult to read due to simplification of illustration, scale, or layout constraints for publication, such difficulty in reading is merely attributable to the schematic nature of the figure and does not limit the technical scope of the present disclosure or affect understanding of the disclosed subject matter or enablement thereof.

The outline of the package may be, for example, one relating to the target package 22 obtained from a website or the like. The possible attacks in progress can be presented in accordance with rules for presenting possible attacks associated with content of APIs used or the like by creating and holding the rules in advance. The possibly anomalous locations may be presented by, for example, determining and presenting locations where many APIs that have contributed to the determination of maliciousness are described.

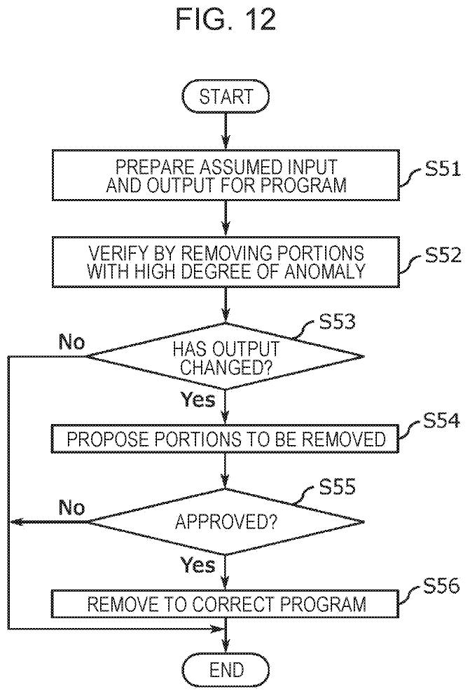

Referring back to FIG. 9, the anomaly removal determiner 18 determines whether to remove the portions where anomalies have been detected (S50). FIG. 12 is a flowchart illustrating another part of the operation of the malicious software determination apparatus according to the embodiment. FIG. 12 illustrates detailed operations in step S50 of FIG. 9.

As illustrated in FIG. 12, first, a set of assumed input and output, such as a test code, is prepared for the program (S51). A change in the output in response to the prepared input is then verified in both a case where the portions where anomalies have been detected have been removed and a case where the portions have not been removed (S52). If the output changes (YES in S53), a removal proposal is presented to the user by including the removal proposal in the visualized information (S54). For example, as illustrated in FIG. 11, options for determining whether to remove the anomalous portions are presented. If the user then approves the removal (YES in S55), the program is corrected by removing the portions (S56). If the output does not change (NO in S53), or if the user does not approve the removal (NO in S55), on the other hand, the process ends without performing step S56.

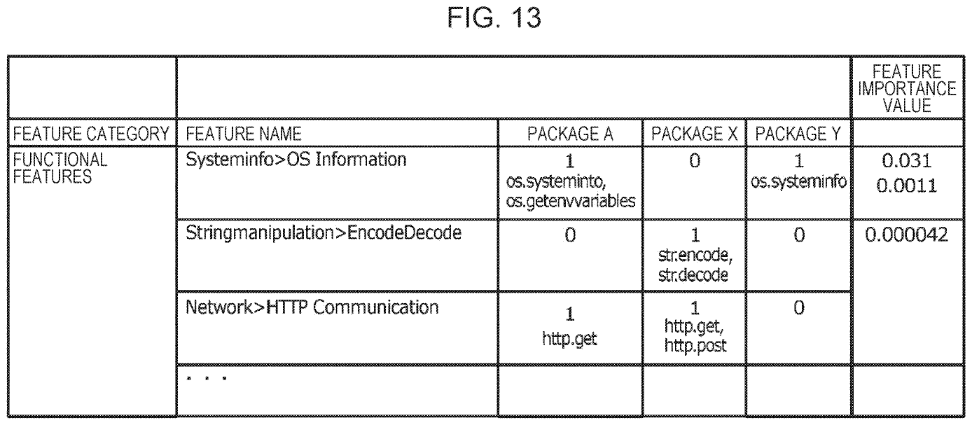

FIG. 13 is a diagram illustrating the information presented by the malicious software determination apparatus according to the embodiment. As illustrated in FIG. 13, for example, it is assumed that there are package A, package X, and package Y determined to be malicious, and whether package A is similar to package X or package Y (reference software) is checked. This similarity information can be used to estimate attacks against package A based on whether package A is more similar to package X or package Y, for which details of attacks have been identified.

First, as illustrated in FIG. 13, the processing is limited to API category features represented by “main category>subcategory”. For a constant M, API category features of package A having feature importance values ranked within top M are extracted, and APIs actually used and included therein are extracted (hereinafter referred to as an “important API list”).

Important API lists contributing to anomaly determination are extracted respectively from the two packages X and Y for which similarity to package A is to be checked. The sum of feature importance values of APIs included in a set (important API list of package X)∩(important API list of package A) or a set (important API list of package Y)∩(important API list of package A), and a sum of feature importance values of APIs included in a set (important API list of package X)∪(important API list of package A) or a set (important API list of package Y)∪(important API list of package A), are then calculated. A value obtained by dividing the former sum by the latter sum may be defined as a degree of similarity.

Furthermore, when a similarity factor for feature importance values is APIs used by the malicious package within the important API list, feature importance values of API categories to which the APIs belong may be used as feature importance values of the APIs.

### Other Embodiments

Although an embodiment has been described, the present disclosure is not limited to the above embodiment.

For example, processing performed by a specific processor may be performed by another processor, instead. Order of a plurality of processing steps may be changed, or a plurality of processing steps may be performed in parallel with each other.

In addition, in the above embodiment, each constituent element may be achieved by executing a software program suitable for the constituent element. Each constituent element may be achieved when a program executer such as a central processing unit (CPU) or a processor reads and executes a software program stored in a storage medium such as a hard disk or a semiconductor memory.

Alternatively, each constituent element may be achieved by hardware. For example, each constituent element may be a circuit (or an integrated circuit). These circuits may together form a single circuit, or may be discrete circuits. In addition, these circuits may be general-purpose circuits or dedicated circuits.

In addition, general or specific aspects of the present disclosure may be implemented as a system, an apparatus, a method, an integrated circuit, a computer program, a computer-readable storage medium such as a CD-ROM, or any selective combination thereof.

For example, the present disclosure may be implemented as a determination method executed by a computer or a program for causing a computer to execute the determination method. The present disclosure may be implemented as a non-transitory computer-readable storage medium storing the program.

The present disclosure also includes modes obtained by modifying each embodiment in ways conceivable by those skilled in the art and modes achieved by arbitrarily combining constituent elements and functions in each embodiment without deviating from the spirit of the present disclosure.

The present disclosure is useful for determining whether software is malicious.

What is claimed is:

1. A determination method for determining whether target software is malicious, the determination method being executed by a computer, each piece of software including one or more functional units, the determination method comprising:
extracting functional unit category information regarding the one or more functional units included in the target software, the functional unit category information being used to classify the one or more functional units into common categories in a first language for describing software and a second language for describing software, the second language being different from the first language; and
determining, based on the extracted functional unit category information, whether the target software is malicious.

2. The determination method according to claim 1,
wherein, in the determining, whether the target software is malicious is determined by inputting the extracted functional unit category information to a maliciousness determination model trained using at least one of the functional unit category information regarding the one or more functional units included in benign software or the functional unit category information regarding the one or more functional units included in malicious software.

3. The determination method according to claim 2, further comprising:
constructing the maliciousness determination model using at least one of the functional unit category information regarding the one or more functional units included in the benign software or the functional unit category information regarding the one or more functional units included in the malicious software.

4. The determination method according to claim 3,
wherein, in the constructing, adjustments for reducing a covariate shift between a distribution of the functional unit category information regarding the one or more functional units included in the target software and a distribution of the functional unit category information used to train the maliciousness determination model are made for the maliciousness determination model.

5. The determination method according to claim 2,
wherein the target software is described in a language different from a language for describing at least one of the malicious software or the benign software including the one or more functional units relating to the functional unit category information used to train the maliciousness determination model.

6. The determination method according to claim 1,
wherein, in the determining, a score indicating a likelihood that the target software is malicious is calculated based on the extracted functional unit category information, and whether the target software is malicious is determined based on the calculated score.

7. The determination method according to claim 1,
wherein the one or more functional units are application programming interfaces (APIs).

8. The determination method according to claim 1, further comprising:
calculating a degree of similarity between the functional unit category information regarding the one or more functional units included in the target software determined to be malicious and the functional unit category information regarding the one or more functional units included in reference software known to be malicious; and
identifying, based on a result of the calculating, the reference software including the one or more functional units relating to the functional unit category information similar to the functional unit category information regarding the one or more functional units included in the target software determined to be malicious.

9. The determination method according to claim 1, further comprising:
estimating, in the target software determined to be malicious, a degree of contribution of each of the one or more functional units to the determination that the target software is malicious, and determining, based on a result of the estimating, a location in the target software where a malicious functional unit, among the one or more functional units, that contributes to the determination that the target software is malicious is described.

10. The determination method according to claim 1, further comprising:
estimating, in the target software determined to be malicious, a degree of contribution of each of the one or more functional units to the determination that the target software is malicious, and generating, based on a result of the estimating, information regarding an anomaly in the target software expected from, among the one or more functional units, a malicious functional unit that contributes to the determination that the target software is malicious.

11. The determination method according to claim 1, further comprising:
estimating, in the target software determined to be malicious, a degree of contribution of each of the one or more functional units to the determination that the target software is malicious, and removing, among the one or more functional units, a malicious functional unit that contributes to the determination that the target software is malicious from the target software based on a result of the estimating.

12. A non-transitory computer-readable storage medium storing a program causing the computer to execute the determination method according to claim 1.

13. A determination apparatus that determines whether target software is malicious, each piece of software including one or more functional units, the determination apparatus comprising:
an extractor that extracts functional unit category information regarding the one or more functional units included in the target software, the functional unit category information being used to classify the one or more functional units into common categories in a first language for describing software and a second language for describing software, the second language being different from the first language; and
a determiner that determines, based on the extracted functional unit category information, whether the target software is malicious.
